(19) United States
(12) Patent Application Publication
(10) Pub. No.: US 2018/0062172 A1
(43) Pub. Date: Mar. 1, 2018

(54) POSITIVE ACTIVE MATERIAL, POSITIVE ELECTRODE INCLUDING THE SAME, AND LITHIUM SECONDARY BATTERY INCLUDING THE POSITIVE ACTIVE MATERIAL

(71) Applicant: SAMSUNG SDI CO., LTD., Yongin-si (KR)

(72) Inventors: Sooyoun PARK, Yongin-si (KR); Changwook KIM, Yongin-si (KR); Yongchan YOU, Yongin-si (KR); Daehoe LEE, Yongin-si (KR); Sangwoo CHO, Yongin-si (KR)

(21) Appl. No.: 15/685,334

(22) Filed: Aug. 24, 2017

(30) Foreign Application Priority Data
Aug. 26, 2016 (KR) 10-2016-0109540

(51) Int. Cl. H01M 4/525; C01G 51/00; H01M 10/0525; H01M 4/131; H01M 4/1391

(52) U.S. Cl. CPC H01M 4/525; C01G 51/42; H01M 4/1391; H01M 4/131; H01M 10/0525

(57) ABSTRACT

A positive active material, a positive electrode, and a lithium secondary battery, the positive active material including a lithium cobalt oxide compound, wherein the lithium cobalt oxide compound includes magnesium in a range of about 0.1 mol % to about 2 mol %, based on a total number of moles of transition metals in the lithium cobalt oxide compound, and a thickness of a lithium layer in the lithium cobalt oxide compound is in a range of about 2.62 Å to about 2.65 Å.

### CROSS-REFERENCE TO RELATED APPLICATION

Korean Patent Application No. 10-2016-0109540, filed on Aug. 26, 2016, in the Korean Intellectual Property Office, and entitled: “Positive Active Material, Positive Electrode Including the Same, and Lithium Secondary Battery Including the Positive Active Material,” is incorporated by reference herein in its entirety.

### BACKGROUND

### 1. Field

Embodiments relate to a positive active material, a positive electrode including the same, and a lithium battery including the positive active material.

### 2. Description of the Related Art

Lithium batteries used in portable electronic devices for information communication, such as personal digital assistants (PDAs), mobile phones, or notebook computers, as well as those used in electrical bicycles and electrical vehicles, may have a discharge voltage of at least twice that of batteries of the related art, and thus have higher energy density.

### SUMMARY

Embodiments are directed to a positive active material, a positive electrode including the same, and a lithium battery including the positive active material.

The embodiments may be realized by providing a positive active material comprising a lithium cobalt oxide compound, wherein the lithium cobalt oxide compound includes magnesium in a range of about 0.1 mol % to about 2 mol %, based on a total number of moles of transition metals in the lithium cobalt oxide compound, and a thickness of a lithium layer in the lithium cobalt oxide compound is in a range of about 2.62 Å to about 2.65 Å.

Magnesium may be doped in a cobalt-containing transition metal layer in the lithium cobalt oxide compound.

A lithium/cobalt molar ratio in the lithium cobalt oxide compound may be about 1±α, wherein 0≦α≦0.025.

A lithium/cobalt molar ratio in the lithium cobalt oxide compound may be 1.

An average particle diameter (D50) in the lithium cobalt oxide compound may be in a range of about 1 μm to about 50 μm.

The positive active material may further include at least one selected from LiNiO₂, LiMnO₂, LiMn₂O₄, Li(NiₐCo_{b}Al_{c})O₂, Li(NiₐCo_{b}Mn_{c})O₂, in which 0<α<1, 0<b<1, 0<c<1, and a+b+c=1, LiNi_{1-Y}Co_{Y}O₂, LiCo_{1-Y}Mn_{Y}O₂, LiNi_{1-Y}Mn_{Y}O₂, which 0≦Y<1, Li(NiₐCo_{b}Mn_{c})O₄, in which 0<α<2, 0<b<2, 0<c<2, and a+b+c=2, LiMn_{2-z}Ni_{z}O₄, LiMn_{2-z}Co_{z}O₄, in which 0<Z<2, LiCoPO₄, LiFePO₄, LiFePO₄, V₂O₅, TiS, and MoS.

The embodiments may be realized by providing a positive electrode for a lithium secondary battery, the positive electrode including the positive active material according to an embodiment.

The embodiments may be realized by providing a lithium secondary battery including a positive electrode including the positive active material as claimed in claim 1; a negative electrode facing the positive electrode; and an electrolyte between the positive electrode and the negative electrode.

The lithium secondary battery may operate at a voltage in a range of about 4.3 V to about 4.5 V.

### BRIEF DESCRIPTION OF THE DRAWINGS

Features will be apparent to those of skill in the art by describing in detail exemplary embodiments with reference to the attached drawings in which:

FIG. 1 illustrates a schematic view of a lithium secondary battery according to an embodiment;

FIG. 2 illustrates a scanning electron microscope (SEM) image showing observation results of a positive active material prepared according to Example 1;

FIG. 3 illustrates an X-ray diffraction (XRD) analysis graph showing measurements of positive active materials prepared according to Examples 1 to 3 and Comparative Examples 1 to 4;

FIG. 4 illustrates a graph showing measurements of thicknesses of a lithium layer and a transition metal layer of positive active materials according to magnesium doping amounts;

FIG. 5 illustrates a graph showing measurements of initial capacity of lithium batteries prepared according to Examples 1-3 and Comparative Examples 1-4;

FIG. 6 illustrates a graph showing measurements of rate characteristics of lithium secondary batteries prepared according to Examples 1-3 and Comparative Examples 1-4; and

FIGS. 7A to 7E illustrate SEM images showing a morphology of a positive active material according to a Mg doping amount.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “and/or” includes any and all combinations of one or more of the associated listed items. Expressions such as “at least one of,” when preceding a list of elements, modify the entire list of elements and do not modify the individual elements of the list.

A positive active material according to an embodiment may include, e.g., a lithium cobalt oxide compound that includes magnesium (Mg) in a range of about 0.1 mol % to about 2 mol %, based on a total amount (moles) of transition metals (in the lithium cobalt oxide compound. In an implementation, the lithium cobalt oxide compound may include a lithium layer. In an implementation, a thickness of the lithium layer of the lithium cobalt oxide compound may be, e.g., in a range of about 2.62 Å to about 2.65 Å.

In an implementation, the lithium cobalt oxide compound may include a cobalt-containing transition metal layer. Magnesium (Mg) may be doped in the Co-containing transition metal layer in the lithium cobalt oxide compound. In an implementation, the Co-containing transition metal layer in the lithium cobalt oxide compound may be doped with Mg in an amount ranging from, e.g., about 0.1 mol % to about 2 mol %, based on a total amount (total number of moles) of transition metals in the lithium cobalt oxide compound. In an implementation, a lattice constant of a lithium layer may be widened so that a thickness of the lithium layer in the lithium cobalt oxide compound may be in a range of, e.g., about 2.62 Å to about 2.65 Å. Compared to pure lithium cobalt oxide (LiCoO₂), e.g., undoped with magnesium, the lithium cobalt oxide compound according to an embodiment may help improve rate characteristics and lifespan characteristics of a lithium secondary battery while maintaining initial capacity of the lithium secondary battery.

Maintaining the amount of Mg at about 0.1 mol % or greater may help ensure that the thickness of the lithium layer is sufficiently widened, thus helping to reduce and/or prevent degradation of lifespan characteristics of the lithium secondary battery. Maintaining the amount of Mg at about 2 mol % or less may help prevent a dramatic fall of the initial capacity of the secondary battery. For example, when the amount of Mg and the thickness of the lithium layer are simultaneously within the ranges above, rate characteristics and lifespan characteristics of the lithium secondary battery may improve while maintaining initial capacity of the lithium secondary battery.

In an implementation, the positive active material (e.g., the lithium cobalt oxide compound) may include Mg in a range of about 0.1 mol % to about 2 mol %, e.g., about 0.2 mol % to about 1.5 mol % or about 0.25 mol % to about 1 mol %, based on a total amount of transition metals in the lithium cobalt oxide compound.

The thickness of the lithium layer may be measured according to X-ray diffraction (XRD) analysis. In an implementation, the thickness of the lithium layer may be in a range of about 2.62 Å to about 2.65 Å, e.g., about 2.62 Å to about 2.64 Å.

In an implementation, the positive active material (e.g., the lithium cobalt oxide compound) may have a Li/Co molar ratio of, e.g., about 1±α, in which 0≦α≦0.025 (e.g., the Li/Co molar ratio may be about 0.975:1 to about 1.025:1). For example, depending on an amount of Mg to be doped, an amount of Li may be decreased so that the Li/Co molar ratio may be adjusted to be about 1±α (wherein 0≦α≦0.025).

In general, when a Co-containing transition metal layer in a lithium cobalt oxide compound is doped with a metallic element different from Co, an amount of Co may be decreased as much as an amount of a doping element, and accordingly the Li/Co molar ratio may be dramatically increased. For example, a large Li/Co molar ratio may lead to degradation of rate characteristics and cycle characteristics of a lithium secondary battery.

In an implementation, the Li/Co molar ratio in the lithium cobalt oxide compound may be adjusted to be about 1±α (wherein 0≦α≦0.025), so that the lithium cobalt oxide compound may exhibit relative dominance in aspects such as initial capacity, rate characteristics, and lifespan characteristics. The closer the Li/Co molar ratio is to about 1, the greater the improvement may be in initial capacity, rate characteristics, and lifespan characteristics of the lithium secondary battery. For example, the Li/Co molar ratio in the lithium cobalt oxide compound may be 1.

In an implementation, an average particle diameter (D50) of the lithium cobalt oxide compound may be about 50 μm or less, e.g., may be in a range of about 1 to about 50 μm, about 5 to about 30 μm, or about 10 to about 20 μm.

The term “D50” used herein refers to an accumulated average diameter corresponding to 50 volume % in the accumulative particle size distribution curve based on a total volume of 100%. The D50 may be measured by using one of various suitable methods in the art, e.g., may be measured by using a particle size analyzer or a transmission electron microscope (TEM) image or a scanning electron microscope (SEM) image. For example, the D50 may be measured by analyzing data measured by a measuring device using a dynamic light-scattering method to count the number of particles for each particle size range and calculating an average value thereof.

In an implementation, the positive active material may be able to intercalate and/or deintercalate lithium ions reversibly, and may further include a suitable positive electrode material. For example, the positive electrode material may further include LiₐA_{1-b}X_{b}D₂ (wherein 0.90≦a≦1.8 and 0≦b≦0.5); LiₐA_{1-b}X_{b}O_{2-c}D_{c} (wherein 0.90≦a≦1.8, 0≦b≦0.5, and 0≦c≦0.05); LiE_{2-b}X_{b}O_{4-c}D_{c} (wherein 0≦b≦0.5 and 0≦c≦0.05); LiₐNi_{1-b-c}Co_{b}X_{c}D_{α} (wherein 0.90≦a≦1.8, 0≦b≦0.5, 0≦c≦0.05, and 0<α≦2); LiₐNi_{1-b-c}Co_{b}X_{c}O_{2-α} T_{α} (wherein 0.90≦a≦1.8, 0≦b≦0.5, 0≦c≦0.05, and 0<α<2); LiₐNi_{1-b-c}Co_{b}X_{c}O_{2-α} T₂ (wherein 0.90≦a≦1.8, 0≦b≦0.5, 0≦c≦0.05, and 0≦α≦2); LiₐNi_{1-b-c}Mn_{b}X_{c}D_{α} (wherein 0.90≦a≦1.8, 0≦b≦0.5, 0≦c≦0.05, and 0≦α≦2); LiₐNi_{1-b-c}Mn_{b}X_{c}O_{2-α} T_{α} (wherein 0.90≦a≦1.8, 0≦b≦0.5, 0≦c≦0.05, and 0≦α≦2); LiₐNi_{1-b-c}Mn_{b}X_{c}O_{2-α} T₂ (wherein 0.90≦a≦1.8, 0≦b≦0.5, 0≦c≦0.05, and 0≦α≦2); LiₐNi_{b}E_{c}G_{d}O₂ (wherein 0.90≦a≦1.8, 0≦b≦0.9, 0≦c≦0.5, and 0.001≦d≦0.1); LiₐNi_{b}Co_{c}Mn_{d}GₑO₂ (wherein 0.90≦a≦1.8, 0≦b≦0.9, 0≦c≦0.5, 0≦d≦0.5, and 0.001≦e≦0.1); LiₐNiG_{b}O₂ (wherein 0.90≦a≦1.8 and 0.001≦b≦0.1); LiₐCoG_{b}O₂ (wherein 0.90≦a≦1.8 and 0.001≦b≦0.1); LiₐMnG_{b}O₂ (wherein 0.90≦a≦1.8 and 0.001≦b≦0.1); LiₐMn₂G_{b}O₄ (wherein 0.90≦a≦1.8 and 0.001≦b≦0.1); QO₂; QS₂; LiQS₂; V₂O₅; LiV₂O₅; LiZO₂; LiNiVO₄; Li_{(3-f)}J₂(PO₄)₃ (wherein 0≦f≦2); Li_{(3-f)}Fe₂(PO₄)₃ (wherein 0≦f≦2); and LiFePO₄.

Here, A may be selected from the group of nickel (Ni), Co, manganese (Mn), and a combination thereof; X may be selected from the group of aluminum (Al), nickel (Ni), Co, Mn, chromium (Cr), iron (Fe), Mg, strontium (Sr), vanadium (V), a rare-earth element, and a combination thereof; D may be selected from the group of oxygen (O), fluorine (F), sulfur (S), phosphorus (P), and a combination thereof; E may be selected from the group of Co, Mn, and a combination thereof; T may be selected from the group of F, S, P, and a combination thereof; G may be selected from the group of Al, Cr, Mn, Fe, Mg, lanthanum (La), cerium (Ce), Sr, V, and a combination thereof; Q may be selected from the group of titanium (Ti), molybdenum (Mo), Mn, and a combination thereof; Z may be selected from the group of Cr, V, Fe, scandium (Sc), yttrium (Y), and a combination thereof; and J may be selected from the group of V, Cr, Mn, Co, Ni, copper (Cu), and a combination thereof.

For example, the positive active material may further include at least one selected from LiCoO₂, LiNiO₂, LiMnO₂, LiMn₂O₄, Li(NiₐCo_{b}Alₑ)O₂, Li(NiₐCo_{b}Mnₑ)O₂ (wherein 0<α<1, 0<b<1, 0<c<1, and a+b+c=1), LiNi_{1-Y}Co_{Y}O₂, LiCo_{1-y}Mn_{Y}O₂, LiNi_{1-Y}Mn_{Y}O₂ (wherein 0≦Y<1), Li(NiₐCo_{b}Mn_{c})O₄ (wherein 0<α<2, 0<b<2, 0<c<2, and a+b+c=2), LiMn_{2-z}Ni_{z}O₄, LiMn_{2-z}Co_{z}O₄ (wherein 0<Z<2), LiCoPO₄, LiFePO₄, LiFePO₄, V₂O₅, TiS, and MoS.

In an implementation, the positive active material may be prepared by performing a wet process or a dry process. For example, the positive active material may be prepared by performing a method described below.

In an implementation, a method of preparing the positive active material may include: preparing a mixed solution of a Li-source material, a Co-source material, and a Mg-source material; and performing heat treatment on the mixed solution. In an implementation, the Mg-source material may include Mg in a range of about 0.1 mol % to about 2 mol % based on a total amount of transition metals.

Examples of the Li-source material include Li₂CO₃, LiNO₃, and Li₃PO₄. Examples of the Co-source material include CoSO₄, CoCl₂, and CoO. Examples of the Mg-source material include MgO₂ and MgSO₄.

A solvent used in the mixed solution may include, e.g., water, alcohol including ethanol and propanol, an organic solvent including hexane, heptane, N-methyl-2 pyrrolidone (NMP), or a mixture thereof.

Afterwards, the mixed solution may be subjected to heat treatment. In an implementation, the heat treatment may be performed, e.g., in air (e.g., ambient atmospheric conditions) at a temperature of about 10° C. to about 100° C.

According to an embodiment, a positive electrode may include the positive active material, and a method of preparing the positive electrode will be described together with a method of preparing a lithium secondary battery.

According to an embodiment, a lithium secondary battery may include a positive electrode including the positive active material; a negative electrode facing the positive electrode; and an electrolyte between the positive electrode and the negative electrode.

The positive electrode may include the positive active material, and may be prepared by, e.g., mixing the positive active material, a conducting agent, and a binder in a solvent to prepare a positive active material composition, and molding the positive active material composition to have a predetermined shape or coating a current collector such as a copper foil with the positive active material composition.

The conducting agent included in the positive active material composition may help increase an electrical conductivity by providing a conduction pathway to the positive active material. The conducting agent may include a suitable conducting material for a lithium battery. Examples of the conducting agent may include a carbon-based material such as carbon black, acetylene black, Ketjen black, or carbon fiber (e.g., vapor growth carbon fiber); a metal-based material such as a metal powder or metal fiber of copper, nickel, aluminum, or silver; a conductive polymer such as a polyphenylene derivative; or a conducting material including a mixture thereof. An amount of the conducting agent may be appropriately controlled. For example, a weight ratio of the positive active material and the conducting agent may be in a range of about 99:1 to about 90:10.

The binder included in the positive active material composition may contribute to binding of the positive active material and the conducting agent and binding of the positive active material to the current collector. An amount of the binder may be in a range of about 1 part to about 50 parts by weight, based on 100 parts by weight of the positive active material. In an implementation, an amount of the binder may be in a range of about 1 part to about 30 parts by weight, for example, about 1 part to about 20 parts by weight, or about 1 part to about 15 parts by weight, based on 100 parts by weight of the positive active material. Examples of the binder may include various polymers such as polyvinylidene fluoride (PVdF), polyvinylidene chloride, polybenzimidazole, polyimide, polyvinyl acetate, polyacrylonitrile, polyvinyl alcohol, carboxymethylcellulose (CMC), starch, hydroxypropylcellulose, reproduced cellulose, polyvinylpyrrolidone, tetrafluoroethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenyl sulfide, polyamideimide, polyetherimide, polyethylene sulfone, polyamide, polyacetal, polyphenylene oxide, polybutylene terephthalate, ethylene-propylene-diene monomer (EPDM), sulfonated EPDM, styrene butadiene rubber (SBR), fluorine rubber, or a combination thereof.

Examples of the solvent may include N-methylpyrrolidone (NMP), acetone, and water. An amount of the solvent may be in a range of about 1 part to about 100 parts by weight based on 100 parts by weight of the positive active material. When the amount of the solvent is within this range, an active material layer may be easily formed.

In an implementation, a thickness of the current collector may be in a range of about 3 μm to about 500 μm, and may be any of various suitable current collectors that do not cause a chemical change to a battery and has high conductivity. Examples of the current collector for a positive electrode may include stainless steel, aluminum, nickel, titanium, calcined carbon, and copper and stainless steel that are surface-treated with carbon, nickel, titanium, or silver. The current collector for a positive electrode may have an uneven micro structure at its surface to enhance a binding force with the positive active material. Also, the current collector may be used in various forms including a film, a sheet, a foil, a net, a porous body, a foaming body, or a non-woven body.

In an implementation, the positive active material composition may be directly coated on a current collector, or the positive active material composition may be cast on a separate support to form a positive active material film, which may then be separated from the support and laminated on a copper foil current collector to prepare a positive electrode plate.

The positive active material composition may be printed on a flexible electrode substrate to manufacture a printable battery, in addition to the use in manufacturing a lithium battery.

Separately, for the manufacture of a negative electrode, a negative active material composition may be prepared by mixing a negative active material, a binder, a solvent, and, optionally, a conducting agent.

The negative active material may be a suitable active material. Examples of the negative active material may include lithium metal, a metal that is alloyable with lithium, a transition metal oxide, a compound capable of doping and de-doping lithium, and a compound capable of reversibly intercalating and deintercalating lithium ions.

Examples of the transition metal oxide may include a tungsten oxide, a molybdenum oxide, a titanium oxide, a lithium titanium oxide, a vanadium oxide, and a lithium vanadium oxide.

Examples of the compound capable of doping and de-doping lithium may include Si; SiOₓ (0<x<2); a Si—Y′ alloy (where Y′ is an alkali metal, an alkali earth metal, a Group 13 element, a Group 14 element, a Group 15 element, a Group 16 element, a transition metal, a rare-earth element, or a combination thereof, but not Si); Sn; SnO₂; and a Sn—Y′ alloy (where Y′ is an alkali metal, an alkali earth metal, a Group 13 element, a Group 14 element, a Group 15 element, a Group 16 element, a transition metal, a rare-earth element, or a combination thereof, but not Sn). In an implementation, at least one of the materials capable of doping and de-doping lithium may be used in combination with SiO₂. In an implementation, Y′ may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (RI), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or combinations thereof.

The compound capable of reversibly intercalating and deintercalating lithium ions may be any one of suitable carbon-based materials for a lithium battery. Examples of the compound capable of reversibly intercalating and deintercalating lithium ions may include crystalline carbon, amorphous carbon, and a mixture thereof. Examples of the crystalline carbon may include natural graphite and artificial graphite, each of which has an amorphous shape, a plate shape, a flake shape, a spherical shape, or a fiber shape. Examples of the amorphous carbon may include soft carbon (low-temperature calcined carbon), hard carbon, meso-phase pitch carbide, and calcined cokes.

The conducting agent, the binder, and the solvent included in the negative active material composition may be the same as those included in the positive active material composition. In an implementation, a plasticizer may be further added to the positive active material composition and to the negative active material composition in order to form pores in a corresponding electrode plate. Amounts of the negative active material, the conducting agent, the binder, and the solvent may be at the same levels suitably used in a lithium secondary battery.

In an implementation, the negative electrode current collector may have a thickness of about 3 μm to about 500 μm, and may be any of various suitable current collectors that do not cause a chemical change to a battery and has high conductivity. Examples of the current collector for a negative electrode may include stainless steel, aluminum, nickel, titanium, calcined carbon, and aluminum and stainless steel that are surface-treated with carbon, nickel, titanium, or silver. The current collector for a negative electrode may have an uneven micro structure at its surface to enhance a binding force with the negative active material. In an implementation, the current collector may be used in various forms including a film, a sheet, a foil, a net, a porous body, a foaming body, a non-woven body.

The negative active material thus prepared may be directly coated on the current collector for a negative electrode to form a negative electrode plate, or may be cast onto a separate support and a negative active material film separated from the support is laminated on the current collector for a negative electrode.

The positive electrode and the negative electrode may be separated by a separator, and the separator may be any of suitable separators for a lithium battery. For example, the separator may include a material that has a low resistance to migration of ions of an electrolyte and an excellent electrolytic solution-retaining capability. For example, the separator may include a material selected from glass fiber, polyester, Teflon, polyethylene, polypropylene, polytetrafluoroethylene (PTFE), and a combination thereof, each of which may be non-woven or woven. The separator may have a pore diameter in a range of about 0.01 μm to about 10 μm, and a thickness in a range of about 5 μm to about 300 μm.

A lithium salt-containing non-aqueous electrolyte solution includes a non-aqueous electrolyte and a lithium salt. Examples of the non-aqueous electrolyte may include a non-aqueous electrolyte solution, a solid electrolyte, and an inorganic solid electrolyte.

The non-aqueous electrolyte solution may be an aprotic organic solvent, and examples of the aprotic organic solvent may include N-methyl-2-pyrrolidone, propylene carbonate, ethylene carbonate, butylene carbonate, dimethyl carbonate, diethyl carbonate, gamma-butyrolactone, 1,2-dimethoxy ethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxymethane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Examples of the organic solid electrolyte may include polyethylene derivatives, polyethylene oxide derivatives, polypropylene oxide derivatives, phosphoric acid ester polymers, polyagitation lysine, polyester sulfide, polyvinyl alcohols, polyvinylidene fluoride, and polymers containing ionic dissociation groups.

Examples of the inorganic solid electrolyte may include nitrides, halides, and sulfates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt may be any lithium salt that is suitably used in a lithium battery and that it is soluble in the non-aqueous electrolyte. For example, the lithium salt may include at least one selected from LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carbonate, lithium tetraphenyl borate, and lithium imide.

Lithium batteries may be classified as lithium ion batteries, lithium ion polymer batteries, and lithium polymer batteries according to the types of a separator and an electrolyte used therein. In addition, lithium batteries may be classified as a cylindrical type, a rectangular type, a coin type, and a pouch type according to a battery shape, and may also be classified as a bulk type and a thin type according to a battery size.

A method of manufacturing a lithium battery is widely known in the art, and thus detailed description thereof will not be provided herein.

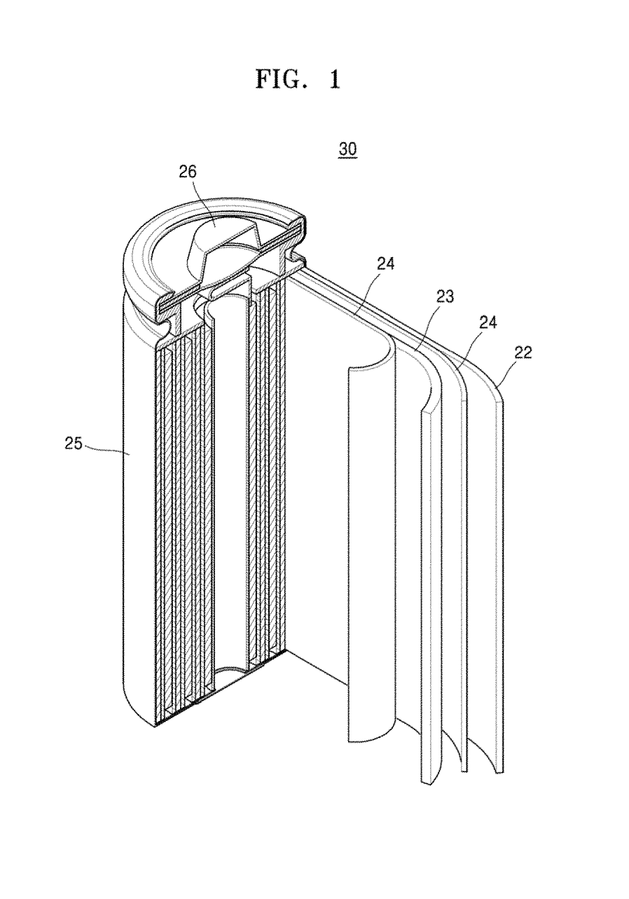

FIG. 1 illustrates a schematic view of a structure of a lithium battery 30 according to an embodiment.

Referring to FIG. 1, the lithium battery 30 may include a positive electrode 23, a negative electrode 22, and a separator 24 between the positive electrode 23 and the negative electrode 22. The positive electrode 23, the negative electrode 22, and the separator 24 may be wound or folded, and then accommodated in a battery case 25. Subsequently, an electrolyte may be injected into the battery case 25, and the battery case 25 may be sealed by a sealing member 26, thereby completing the manufacture of the lithium battery 30. The battery case 25 may have, e.g., a cylindrical shape, a rectangular shape, or a thin-film shape. The lithium battery 30 may be a lithium ion battery.

The lithium battery may be suitable to be used as a battery, as power sources, of small-sized devices such as mobile phones or portable computers, or as a unit battery of a battery module including a plurality of batteries in a medium-to-large-sized device.

Examples of the medium-to-large-sized device may include a power tool; an xEV such as an electric vehicle (EV), a hybrid electric vehicle (HEV), and a plug-in hybrid electric vehicle; electric bicycles such as E-bike or E-scooter; an electric golf cart; an electric truck; an electric commercial vehicle; or an electric power storage system. Also, the lithium battery may be suitable for use requiring a high output, a high voltage, and high temperature operability. The lithium battery may be used in applications that require a high voltage range of about 4.3 V to about 4.6 V. That is, the lithium battery is able to operate even when the upper voltage is about 4.3 V to about 4.6 V.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

(1) Preparation of 0.25 Mol % Mg-Doped LCO

0.25 mol % Mg-doped LCO was prepared as follows.

46 g of Li₂CO₃ (available from Aldrich), 100 g of Co₃O₄ (available from Aldrich), and 0.26 g of MgCO₃ (available from Aldrich) were mixed under an air atmosphere, and then, heat treatment was performed thereon at a temperature of 980° C. for 5 hours. After the heat treatment, a positive active material, 0.25 mol % Mg-doped LiCoO₂ (referred to as LCO), was obtained.

(2) Preparation of Lithium Secondary Battery

94 weight % of the prepared positive active material, 3 weight % of carbon black as a conducting agent, and 3 weight % of polyvinylidene difluoride (PVDF) as a binder were dispersed in N-methyl-2-pyrrolidone (NMP), to thereby prepare a slurry for forming a positive electrode. The slurry was coated on an Al thin film, which is a current collector having a thickness in a range of about 20 μm to about 30 μm, and the coated Al thin film was dried and roll-pressed, to thereby prepare a positive electrode.

A lithium electrode was used as a counter electrode of the positive electrode, and an electrolyte solution was prepared by adding LiPF₆ to a solvent including ethylene carbonate (EC), ethylmethyl carbonate (EMC), and dimethylcarbonate (DMC) at a volume ratio of 3:5:2 to prepare a 1.1 M solution.

A separator (formed of a porous polyethylene (PE) film) was disposed between the positive electrode and a negative electrode, to thereby prepare a battery assembly, and the battery assembly was rolled and pressed to be accommodated in a battery case. Then, the battery case was filled with the electrolyte solution, to thereby complete the preparation of a lithium secondary battery (also referred to as a coin half cell, 2016 type).

### Example 2

A positive active material and a lithium secondary battery were prepared according to the same procedure as in Example 1, except that 46 g of Li₂CO₃ (available from Aldrich), 100 g of Co₃O₄ (available from Aldrich), and 0.53 g of MgCO₃ (available from Aldrich) were used to prepare a positive active material of 0.5 mol % Mg-doped LCO.

### Example 3

A positive active material and a lithium secondary battery were prepared according to the same procedure as in Example 1, except that 46 g of Li₂CO₃ (available from Aldrich), 100 g of Co₃O₄ (available from Aldrich), and 1.06 g of MgCO₃ (available from Aldrich) was used to prepare a positive active material of 1 mol % Mg-doped LCO.

### Comparative Example 1

A positive active material and a lithium secondary battery were prepared according to the same procedure as in Example 1, except that non-doped LiCoO₂ was used as a positive active material.

### Comparative Example 2

A positive active material and a lithium secondary battery were prepared according to the same procedure as in Example 1, except that 46 g of Li₂CO₃ (available from Aldrich), 100 g of Co₃O₄ (available from Aldrich), and 4.22 g of MgCO₃ (available from Aldrich) was used to prepare a positive active material of 4 mol % Mg-doped LCO.

### Comparative Example 3

A positive active material and a lithium secondary battery were prepared according to the same procedure as in Example 1, except that 46 g of Li₂CO₃ (available from Aldrich), 100 g of Co₃O₄ (available from Aldrich), and 7.39 g of MgCO₃ (available from Aldrich) was used to prepare a positive active material of 7 mol % Mg-doped LCO.

### Comparative Example 4

A positive active material and a lithium secondary battery were prepared according to the same procedure as in Example 1, except that 46 g of Li₂CO₃ (available from Aldrich), 100 g of Co₃O₄ (available from Aldrich), and 10.55 g of MgCO₃ (available from Aldrich) was used to prepare a positive active material of 10 mol % Mg-doped LCO.

### Evaluation Example 1: Scanning Electron Microscope (SEM) Analysis

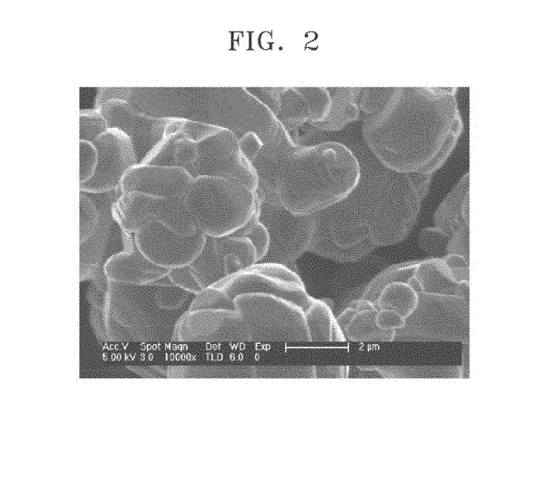

To identify a morphology of the 0.25 mol % Mg-doped LCO of Example 1, the 0.25 mol % Mg-doped LCO of Example 1 was analyzed by using a scanning electron microscope (SEM), and the results are shown in FIG. 2.

As shown in FIG. 2, Mg-doped LCO was in the form of a powder including secondary particles formed by clusters of primary particles agglomerating together, the clusters of primary particles having been prepared by agglomerating primary particles together, wherein a diameter of the secondary particles was confirmed to be in a range of about 5 μm to about 10 μm.

### Evaluation Example 2: X-Ray Diffraction (XRD) Analysis

The positive active materials of Examples 1 to 3 and Comparative Examples 1 to 4 were subjected to XRD analysis (model: X′pert Pro MPD, a manufacturer: PANalytical), to thereby analyze lattice characteristics. Here, a Cu K-alpha characteristic X-ray wavelength of 1.541 Å was used.

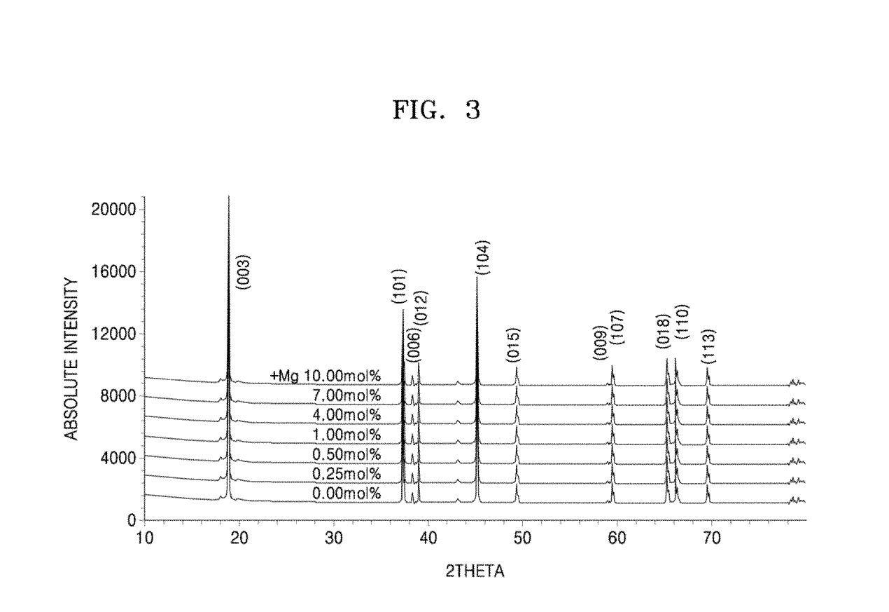

FIG. 3 illustrates a XRD analysis graph showing measurements of the positive active materials of Examples 1 to 3 and Comparative Examples 1 to 4. As shown in FIG. 3, it may be seen that the positive active materials of Examples 1 to 3 and Comparative Examples 1 to 4 were prepared without producing any impurities in the LCO crystal structure.

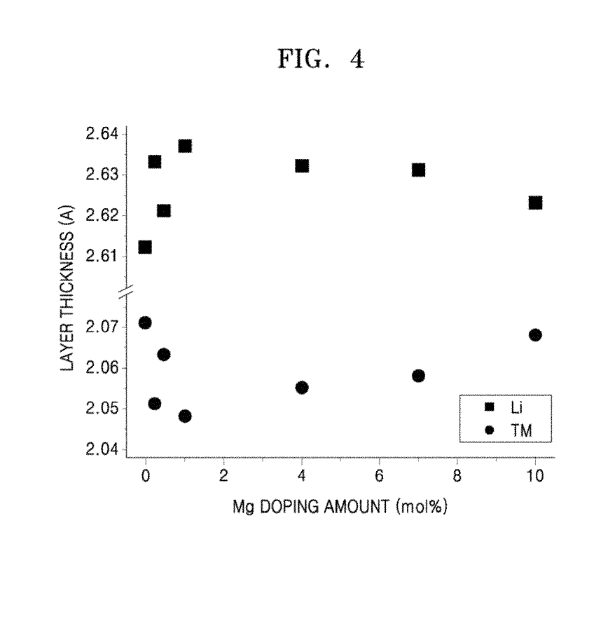

Lattice constants and thicknesses of lithium layers measured based on the results of XRD analysis performed on the positive active materials of Examples 1 to 3 and Comparative Examples 1 to 4 are shown in Table 1. FIG. 4 illustrates a graph showing measurements of thicknesses of lithium layers (▪Li) and transition metal layers (TM) of the positive active materials of Examples 1 to 3 and Comparative Examples 1 to 4. FIG. 4 shows changes in the lithium layers and the transition metal layers according to Mg doping amounts.

TABLE 1

| | | | | | Thickness |
|---|---|---|---|---|---|
| | Mg doping | a | c | V | of Li layer |
| | amount | (Å) | (Å) | (Å ³) | (Å) |
| Example 1 | 0.25 mol % | 2.81608(1) | 14.0538(1) | 96.519 | 2.633 |
| Example 2 | 0.50 mol % | 2.81586(1) | 14.0524(1) | 96.502 | 2.621 |
| Example 3 | 1 mol % | 2.81631(1) | 14.0552(1) | 96.545 | 2.637 |
| Comparative | 0 mol % | 2.81576(1) | 14.0516(1) | 96.482 | 2.612 |
| Example 1 | | | | | |
| Comparative | 4 mol % | 2.81760(1) | 14.0620(1) | 96.680 | 2.632 |
| Example 2 | | | | | |
| Comparative | 7 mol % | 2.81872(2) | 14.0676(1) | 96.795 | 2.631 |
| Example 3 | | | | | |
| Comparative | 10 mol % | 2.81946(2) | 14.0713(1) | 96.872 | 2.623 |
| Example 4 | | | | | |

### Evaluation Example 3: Evaluation of Battery Characteristics

To evaluate battery characteristics according to Mg doping amounts and a thickness of a lithium layer, charging/discharging was performed on the lithium secondary batteries of Examples 1 to 3 and Comparative Examples 1 to 4 under the conditions described below.

Charging/discharging was performed at a temperature of 25° C. To measure a charge/discharge capacity in the first cycle, each of the lithium secondary batteries of Examples 1 to 3 and Comparative Examples 1 to 4 was charged with a constant current at a 0.1 C rate until a voltage reached 4.6 V (vs. Li), and then, was discharged with a constant current at a 0.1 C rate until a voltage reached 3 V (vs. Li) (a formation process, 1^{st} cycle).

After the formation process, each of the lithium secondary batteries of Examples 1 to 3 and Comparative Examples 1 to 4 was charged at a temperature of 25° C. with a constant current at a 0.2 C rate until a voltage reached 4.6 V (vs. Li), and then, was discharged with a constant current at the same rate. Subsequently, each of the lithium secondary batteries of Examples 1 to 3 and Comparative Examples 1 to 4 was charged and discharged with a constant current at a 0.2 C rate, a 0.5 C rate, a 1 C rate, and a 2 C rate, until a voltage reached 4.6 V, so that capacity values each corresponding to the rates were obtained and battery characteristics were evaluated therefrom. Here, the rate characteristics are defined as ratios of the discharge capacity.

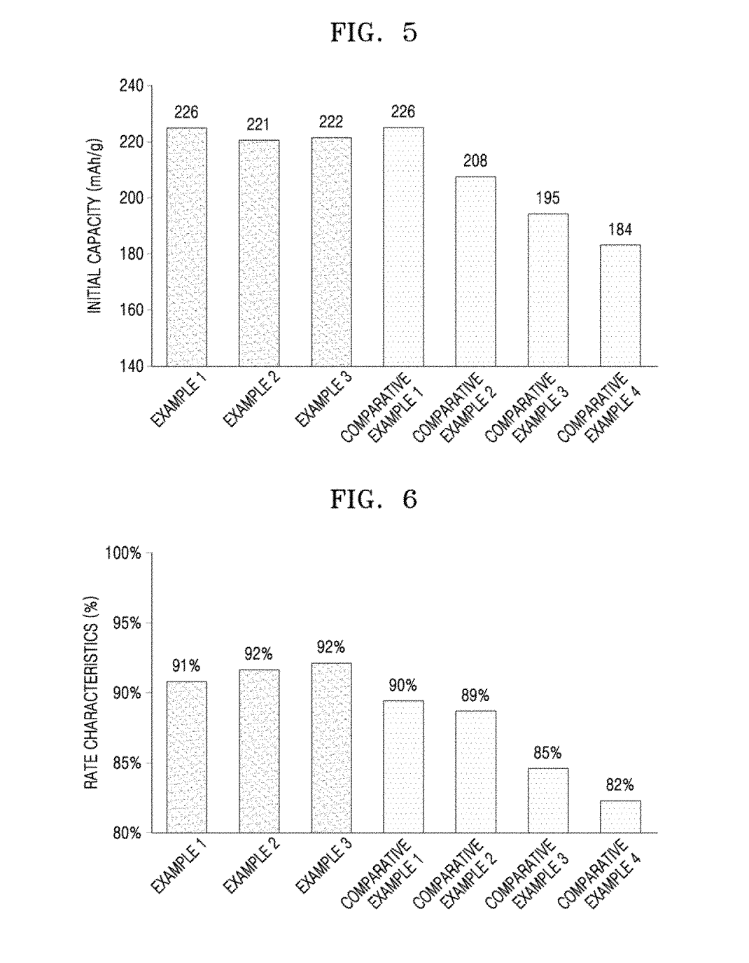

The measurements of initial capacity and rate characteristics of the lithium secondary batteries of Examples 1 to 3 and Comparative Examples 1 to 4 are shown in FIGS. 5 (initial capacity) and 6 (rate characteristics).

To evaluate their lifespan characteristics, after the formation process was completed, each of the lithium secondary batteries of Examples 1 to 3 and Comparative Examples 1 to 4 was charged at a temperature of 25° C. with a constant current at a 1 C rate until a voltage reached 4.6 V (vs. Li), and then, was discharged with a constant current at a 1 C rate until a voltage reached 3 V (vs. Li). The lithium secondary batteries of Examples 1 to 3 and Comparative Examples 1 to 4 underwent 50 cycles of charging/discharging, and the lifespan characteristics of the lithium secondary batteries of Examples 1 to 3 and Comparative Examples 1 to 4 were evaluated based on capacity retention ratios (CRRs) at the 50^{th} cycle of charging/discharging. Here, the CRR was defined according to Equation 1:

Capacity retention ratio (CRR) [%]=[Discharge capacity at 50^{th} cycle/Discharge capacity at 1^{st} cycle]×100 <Equation 1>

The measurements of lifespan characteristics of the lithium secondary batteries of Examples 1 to 3 and Comparative Examples 1 to 4 are shown in Table 2.

TABLE 2

| | Mg | | | Rate | Lifespan |
|---|---|---|---|---|---|
| | doping | Thickness | Initial | Charac- | Charac- |
| | amount | of Li layer | capacity, | teristics | teristics |
| | (mol %) | (Å) | (mAh/g) | (%) | (%) |
| Example 1 | 0.25 | 2.633 | 226 | 91 | 65 |
| Example 2 | 0.50 | 2.621 | 221 | 92 | 75 |
| Example 3 | 1 | 2.637 | 222 | 92 | 68 |
| Comparative | 0 | 2.612 | 226 | 90 | 52 |
| Example 1 | | | | | |
| Comparative | 4 | 2.632 | 208 | 89 | 74 |
| Example 2 | | | | | |
| Comparative | 7 | 2.631 | 195 | 85 | 80 |
| Example 3 | | | | | |
| Comparative | 10 | 2.623 | 184 | 82 | 83 |
| Example 4 | | | | | |

Referring to FIGS. 5 and 6 and Table 2, it may be seen that, compared to the lithium secondary batteries of Comparative Examples 1 to 4, the lithium secondary batteries of Examples 1 to 3 exhibited improved rate characteristics, but similar initial capacity and lifespan characteristics.

### Evaluation Example 4: Battery Characteristics at High Temperature According to Mg Doping Amount

To evaluate battery characteristics at high temperatures according to Mg doping amounts, positive active materials and lithium secondary batteries were prepared according to the same procedure as in Example 1, except that amounts of raw materials were adjusted so that the Mg doping amounts were 0.5 mol %, 1.0 mol %, 2.0 mol %, 3.0 mol %, and 4.0 mol %.

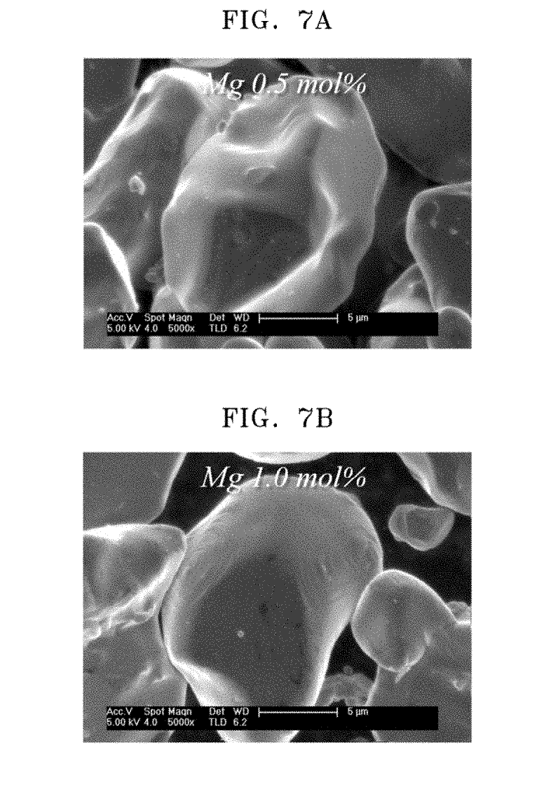

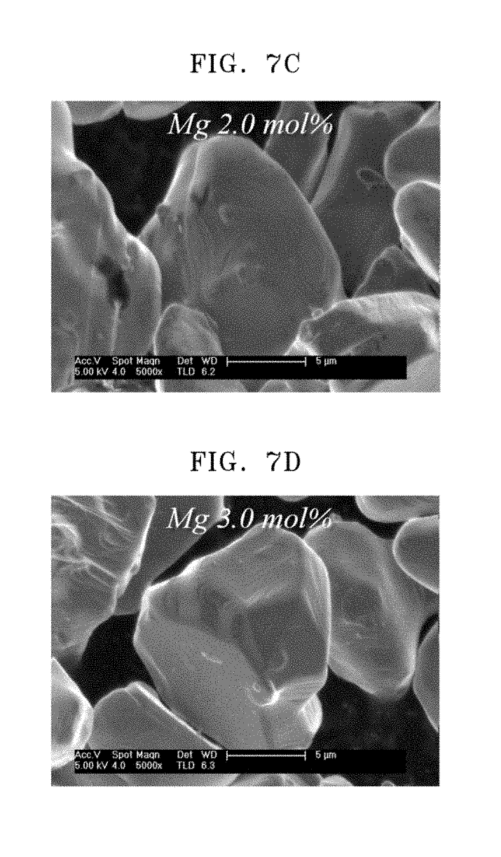

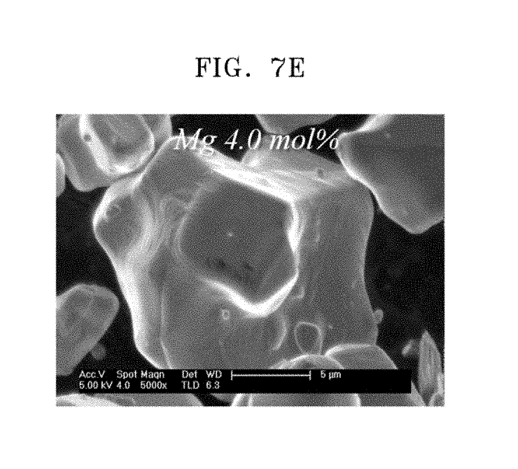

SEM images of the positive active materials prepared according to the different Mg doping amounts are shown in FIGS. 7A to 7E. As shown in FIGS. 7A to 7E, it may be seen that the increase in the Mg doping amounts did not cause morphological changes in the positive active materials.

Changes in thicknesses of lithium layers (▪Li) and transition metal layers (TM) of the positive active materials prepared according to the Mg doping amounts are shown in FIG. 4.

To evaluate battery characteristics of the lithium secondary batteries of Evaluation Example 4, the lithium secondary batteries of Evaluation Example 4 were charged with a constant current at a temperature of 45° C. at a 0.1 C rate until a voltage reached 4.6 V (vs. Li), and then, was discharged with a constant current at a 0.1 C rate until a voltage reached 3 V (vs. Li) (a formation process).

After the formation process, each of the lithium secondary batteries of Evaluation Example 4 was charged with a constant current at a temperature of 45° C. at a 0.2 C rate until a voltage reached 4.6 V (vs. Li), and then, was discharged with a constant current at the same rate. Subsequently, each of the lithium secondary batteries of Evaluation Example 4 was charged and discharged with a constant current at a 0.5 C rate, a 1 C rate, and a 2 C rate, until a voltage reached 4.6 V, so that capacity values each corresponding to the rates were obtained and battery characteristics were evaluated therefrom. Here, the initial efficiency (I.E.) was defined as discharge capacity at 1^{st} cycle/charge capacity at 1^{st} cycle, and the rate characteristics are defined as ratios of the discharge capacity as shown in Table 3. The evaluation results of the I.E and rate characteristics of the lithium secondary batteries of Evaluation Example 4 are shown in Table 3.

In addition, regarding the lithium secondary batteries of Evaluation Example 4, charging at a 1.0 C rate and discharging at a 1.0 C rate were performed on the lithium secondary batteries of Evaluation Example 4, to thereby analyze discharge capacity and CRR thereof. Discharge capacities at the 1^{st} and 50^{th} cycle and CRRs at the 50^{th} cycle were measured, and the results are shown in Table 3.

TABLE 3

| Positive | 1^{st} cycle | | | | | | | | | Cycle | | |
|---|---|---|---|---|---|---|---|---|---|---|---|---|
| active | | | ICE | Cap. | Rate characteristics | | | | | characteristics | | CRR |
| material | 0.1 C | 0.1 D | (%) | 0.2 D | 0.5 D | 1 D | 2 D | 1 D/0.1 D | 2 D/0.2 D | 1^{st} D | 50^{th} D | (50cyc) |
| Mg 0.5 | 240 | 234 | 97% | 232 | 228 | 224 | 215 | 96% | 93% | 223 | 171 | 76% |
| mol % | | | | | | | | | | | | |
| Mg 1.0 | 240 | 232 | 97% | 229 | 225 | 220 | 213 | 95% | 93% | 217 | 153 | 71% |
| mol % | | | | | | | | | | | | |
| Mg 2.0 | 235 | 226 | 96% | 224 | 219 | 214 | 207 | 95% | 92% | 210 | 133 | 63% |
| mol % | | | | | | | | | | | | |
| Mg 3.0 | 240 | 223 | 93% | 214 | 206 | 198 | 188 | 89% | 88% | 190 | 106 | 56% |
| mol % | | | | | | | | | | | | |
| Mg 4.0 | 241 | 227 | 94% | 209 | 211 | 205 | 196 | 90% | 89% | 198 | 110 | 55% |
| mol % | | | | | | | | | | | | |

Referring to Table 3, when the Mg doping amount was 2.0 mol % or less, the lithium secondary batteries of Evaluation Example 4 had excellent I.E., rate characteristics, and lifespan characteristics. However, when the Mg doping amount was 3 mol % or more, the lithium secondary batteries of Evaluation Example 4 had reduced initial capacity and I.E. due to the excessive Mg doping amount.

### Evaluation Example 5: Battery Characteristics at Room Temperature According to Li/Co Molar Ratio

To evaluate battery characteristics at room temperature according to Li/Co molar ratios, positive active materials and lithium secondary batteries were prepared according to the same procedure as in Example 1, except that amounts of raw materials were adjusted so that the molar ratios of Li to Co were 0.975, 1.000, 1.015, 1.025, 1.035, and 1.045. Then, battery characteristics of the prepared lithium secondary batteries were evaluated as follows.

Regarding the prepared lithium secondary batteries above, temperatures at which charge/discharge was performed were set in the same manner as in Evaluation Example 4, and then, charge/discharge was performed on the lithium secondary batteries of Evaluation Example 5.

Measurements of I.E., rate characteristics, and CRRs of the lithium secondary batteries of Evaluation Example 5 are shown in Table 4.

TABLE 4

| Positive | 1^{st} cycle | | | | | | | | | Cycle | | |
|---|---|---|---|---|---|---|---|---|---|---|---|---|
| active | | | ICE | Cap. | Rate characteristics | | | | | characteristics | | CRR |
| material | 0.1 C | 0.1 D | (%) | 0.2 D | 0.5 D | 1 D | 2 D | 1 D/0.1 D | 2 D/0.2 D | 1^{st} D | 50^{th} D | (50cyc) |
| Li/Co = | 242 | 235 | 97% | 227 | 219 | 211 | 190 | 90% | 84% | 207 | 128 | 62% |
| 0.970 | | | | | | | | | | | | |
| Li/Co = | 242 | 236 | 97% | 228 | 220 | 212 | 192 | 90% | 84% | 208 | 129 | 62% |
| 0.975 | | | | | | | | | | | | |
| Li/Co = | 244 | 237 | 97% | 229 | 221 | 213 | 192 | 90% | 84% | 209 | 131 | 63% |
| 0.980 | | | | | | | | | | | | |
| Li/Co = | 247 | 240 | 97% | 232 | 224 | 215 | 197 | 90% | 85% | 211 | 134 | 64% |
| 0.990 | | | | | | | | | | | | |
| Li/Co = | 249 | 241 | 97% | 234 | 226 | 218 | 200 | 90% | 85% | 214 | 135 | 63% |
| 1.000 | | | | | | | | | | | | |
| Li/Co = | 247 | 238 | 96% | 228 | 218 | 203 | 185 | 86% | 81% | 197 | 100 | 51% |
| 1.015 | | | | | | | | | | | | |
| Li/Co = | 240 | 230 | 96% | 223 | 214 | 199 | 181 | 86% | 81% | 192 | 97 | 51% |
| 1.025 | | | | | | | | | | | | |
| Li/Co = | 240 | 230 | 96% | 222 | 210 | 195 | 177 | 85% | 80% | 189 | 87 | 46% |
| 1.035 | | | | | | | | | | | | |
| Li/Co = | 235 | 227 | 96% | 218 | 206 | 191 | 173 | 84% | 79% | 184 | 83 | 45% |
| 1.045 | | | | | | | | | | | | |

Referring to Table 4, when the Li/Co molar ratio was in a range of 0.975 to 1.025, the lithium secondary batteries of Evaluation Example 5 had excellent I.E., rate characteristics, and lifespan characteristics. For example, when the Li/Co molar ratio was in a range of 0.990 to 1.000, the lithium secondary batteries of Evaluation Example 5 had relatively improved initial capacity.

By way of summation and review, a lithium secondary battery may include a positive electrode and a negative electrode, each of which includes an active material for intercalation and deintercalation of lithium ions, and an organic electrolytic solution or a polymer electrolytic solution, which fills a space between the positive electrode and the negative electrode. Such a lithium secondary battery generates electrical energy due to oxidation and reduction reactions occurring when lithium ions are intercalated and/or deintercalated from the positive electrode and the negative electrode, and is re-usable by repeated charge and discharge.

The characteristics of the lithium secondary battery are considered in terms of capacity, lifespan, and stability, and depending on an active material used in a battery, primary characteristics of a secondary battery, e.g., an operation voltage and a capacity, are determined. Such primary characteristics may be related to thermodynamic stability of an active material. In a battery, different chemical reactions may occur depending on secondary characteristics, such as types of a binder, compositions of an electrolytic solution, interaction between an electrolytic solution and an active material, and types of an active material. Such secondary characteristics may be identified after configuring a battery, due to changes in chemical environments of a battery resulting from chemical reactions occurring differently depending on battery-constituting elements.

As such, even if thermal stability of a positive active material in batteries were to be secured at a high voltage of at least 4.5 V, concerns regarding alleviating the interaction between an active material and an electrolytic solution may remain.

LiCoO₂, which is a commonly used positive active material in a secondary battery, may have the advantage of high specific capacity, but due to high resistance upon deintercalatation of lithium ions caused by a small thickness of a lithium layer between a transition metal layer and an oxygen layer, rate characteristics and lifespan characteristics may be of concern. Attempts to improve rate characteristics and lifespan characteristics of LiCoO₂ may lead to degradation of the initial capacity of batteries.

According to the one or more embodiments, using the above-described positive active material (instead of pure LiCoO₂) may help improve rate characteristics and lifespan characteristics of a lithium secondary battery, while maintaining initial capacity of the lithium secondary battery.

The embodiments may provide a positive active material capable of improving rate characteristics and lifespan characteristics of a lithium secondary battery while maintaining initial capacity of the lithium secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A positive active material comprising a lithium cobalt oxide compound, wherein:
the lithium cobalt oxide compound includes magnesium in a range of about 0.1 mol % to about 2 mol %, based on a total number of moles of transition metals in the lithium cobalt oxide compound, and
a thickness of a lithium layer in the lithium cobalt oxide compound is in a range of about 2.62 Å to about 2.65 Å.

2. The positive active material as claimed in claim 1, wherein magnesium is doped in a cobalt-containing transition metal layer in the lithium cobalt oxide compound.

3. The positive active material as claimed in claim 1, wherein a lithium/cobalt molar ratio in the lithium cobalt oxide compound is about 1±α, wherein 0≦α≦0.025.

4. The positive active material as claimed in claim 1, wherein a lithium/cobalt molar ratio in the lithium cobalt oxide compound is 1.

5. The positive active material as claimed in claim 1, wherein an average particle diameter (D50) in the lithium cobalt oxide compound is in a range of about 1 μm to about 50 μm.

6. The positive active material as claimed in claim 1, wherein the positive active material further includes at least one selected from LiNiO₂, LiMnO₂, LiMn₂O₄, Li(NiₐCo_{b}Al_{c})O₂, Li(NiₐCo_{b}Mn_{c})O₂, in which 0<α<1, 0<b<1, 0<c<1, and a+b+c=1, LiNi_{1-Y}Co_{Y}O₂, LiCo_{1-Y}Mn_{Y}O₂, LiNi_{1-Y}Mn_{Y}O₂, which 0≦Y<1, Li(NiₐCo_{b}Mn_{c})O₄, in which 0<α<2, 0<b<2, 0<c<2, and a+b+c=2, LiMn_{2-z}Ni_{z}O₄, LiMn_{2-z}Co_{z}O₄, in which 0<Z<2, LiCoPO₄, LiFePO₄, LiFePO₄, V₂O₅, TiS, and MoS.

7. A positive electrode for a lithium secondary battery, the positive electrode including the positive active material as claimed in claim 1.

8. A lithium secondary battery, comprising:
a positive electrode including the positive active material as claimed in claim 1;
a negative electrode facing the positive electrode; and
an electrolyte between the positive electrode and the negative electrode.

9. The lithium secondary battery as claimed in claim 8, wherein the lithium secondary battery operates at a voltage in a range of about 4.3 V to about 4.6 V.
